(19) United States
(12) Patent Application Publication
(10) Pub. No.: US 2013/0265390 A1
(43) Pub. Date: Oct. 10, 2013

(54) STEREOSCOPIC IMAGE DISPLAY PROCESSING DEVICE, STEREOSCOPIC IMAGE DISPLAY PROCESSING METHOD, AND STEREOSCOPIC IMAGE DISPLAY PROCESSING PROGRAM

(71) Applicant: JVC KENWOOD CORPORATION, Yokohama-shi (JP)

(72) Inventor: Hiroshi NOGUCHI, Yokohama-shi (JP)

(73) Assignee: JVC KENWOOD Corporation, Yokohama-shi (JP)

(21) Appl. No.: 13/854,167

(22) Filed: Apr. 1, 2013

(30) Foreign Application Priority Data
Apr. 10, 2012 (JP) 2012-089037
Jun. 27, 2012 (JP) 2012-143772

(51) Int. Cl. H04N 13/00

(52) U.S. Cl. CPC H04N 13/0048
USPC 348/43

(57) ABSTRACT

A decoding section outputs a display image signal based on an input processed image signal after executing 3D decoding processing of the processed image signal based on a 3D format of the processed image signal, or without executing the 3D decoding processing. A determination section determines a state of superimposed text information in the processed image signal. A control section controls the decoding section to execute or not to execute the 3D decoding processing of the processed image signal based on a determination result from the determination section.

### CROSS REFERENCE TO RELATED APPLICATION

This application is based upon and claims the benefit of priority under 35 U.S.C. §119 from Japanese Patent Applications No. 2012-089037, filed on Apr. 10, 2012, and No. 2012-143772, filed on Jun. 27, 2012, the entire contents of both of which are incorporated herein by reference.

### BACKGROUND

The embodiments relate to a stereoscopic image display processing device, a stereoscopic image display processing method, and a stereoscopic image display processing program.

In recent years, 3D televisions (TVs), which are able to display three-dimensional (3D) contents, have been flourishing in the market. The 3DTVs are classified into a glasses method in which 3DTVs are viewed through glasses, and a glasses-free method in which 3DTVs are viewed without the need to wear glasses.

The glasses method includes two types of methods that are a frame sequential method and a line alternative method. In the frame sequential method, left and right (L and R) images are output alternately per frame on a TV side, and viewed using liquid crystal shutter glasses. In the line alternative method, L and R images are output alternately for each line in the same frame on a TV side, and viewed through polarized glasses.

The glasses-free method includes a parallax barrier method, a lenticular method, and so on.

3D contents include broadcast, and package software such as movies and video games. Currently, formats for 3D contents are defined by the high-definition multimedia interface (HDMI) 1.4a specification.

It is specified that a frame-packing format is supported at “1080p@23.98/24 Hz” and “720p@50 or 59.94/60 Hz”, a side-by-side format is supported at “1080i@50 or 59.94/60 Hz”, and a top-and-bottom is supported at “720p@50 or 59.94/60 Hz” and “1080p@23.98/24 Hz”.

The frame-packing format at “1080p” is mainly used for package software of movies, the frame-packing format at “720p” is mainly used for package software of video games, and the side-by-side format is mainly used for broadcast.

When viewing 3D contents on a 3DTV in a 3D viewing mode, images are decoded by the 3DTV in accordance with a 3D format. Images decoded and output are viewed through glasses in the glasses method, and viewed without glasses in the glasses-free method, thereby enabling the images to be viewed stereoscopically.

In viewing 3D broadcast aired by a TV station in a 3D viewing mode, some scenes are aired where a superimposed text showing emergency breaking news and so on is superimposed on the broadcast. When the TV station does not superimpose the same characters at the same positions on L and R images in the side-by-side format, but instead superimposes the superimposed text across the L and R images using an existing text superimposer similarly to 2D broadcast, a problem arises that the superimposed text is not readable in a 3D viewing state.

Japanese Patent Application Publication No. 2010-288234 (Patent Document 1) proposed a method for switching display between 3D and 2D on a receiving device side in accordance with display information contained in broadcast signals, when showing emergency information as a superimposed text while transmitting 3D contents from a transmission side.

### SUMMARY

In order to put the method of Patent Document 1 into practical use, it is required to decide specifications of display information to be contained in broadcast signals, and support the specifications on both transmission side and receiving side. In such a case, it is difficult in reality to decide and support details of specifications on both the transmission side, that is broadcasting stations, and the receiving side, that is receiving devices such as TVs produced by each company.

An object of the embodiments is to provide a stereoscopic image display processing device, a stereoscopic image display processing method, and a stereoscopic image display processing program by which a superimposed text is readable even when viewing 3D broadcast.

A first aspect of the embodiments provides a stereoscopic image display processing device, comprising: a decoding section configured to output a display image signal based on an input processed image signal after executing 3D decoding processing of the processed image signal based on a 3D format of the processed image signal, or without executing the 3D decoding processing; a determination section configured to determine a state of superimposed text information in the input processed image signal; and a control section configured to control the decoding section to execute or not to execute the 3D decoding processing of the processed image signal based on a determination result by the determination section.

A second aspect of the embodiments provides a stereoscopic image display processing method, comprising: determining a state of superimposed text information in an input processed image signal; and controlling execution or non execution of 3D decoding processing of the processed image signal based on a determination result regarding the state of the superimposed text information.

A third aspect of the embodiments provides a stereoscopic image display processing program for causing a computer to execute the instructions, comprising: an instruction for determining a state of superimposed text information in an input processed image, and an instruction for controlling execution or non execution of 3D decoding processing of the processed image signal based on a determination result regarding the state of the superimposed text information.

### BRIEF DESCRIPTION OF THE DRAWINGS

FIG. 1 is a schematic view showing an example of a stereoscopic image display processing device according to an embodiment.

FIG. 2 is a flowchart showing an example of processing executed in a determination section of the stereoscopic image display processing device according to the embodiment.

FIG. 3 is a schematic view showing an example of a decoding section and a control section of the stereoscopic image display processing device according to the embodiment.

FIG. 4 is a schematic view showing an example of an input image in the stereoscopic image display processing device according to the embodiment.

FIG. 5 is a schematic view showing display images processed by a conventional stereoscopic image display processing device.

FIG. 6 is a schematic view showing an example of display images processed by the stereoscopic image display processing device according to the embodiment.

FIG. 7 is a schematic view showing another example of the stereoscopic image display processing device according to the embodiment.

FIG. 8 is a schematic view showing an example of a determination region in a processed image in the stereoscopic image display processing device according to the embodiment.

FIG. 9 is a schematic view showing an example of an input image in a stereoscopic image display processing device according to a modification example of the embodiment.

FIG. 10 is a flowchart showing an example of processing executed at a determination section of the stereoscopic image display processing device according to the modification example of the embodiment.

### DETAILED DESCRIPTION

The embodiments will be explained below with reference to the accompanying drawings. In the following statements regarding the drawings, same or similar parts are denoted by the same or similar reference numerals. However, it should be noted that the drawings are schematic, and a device, a system configuration, and so on illustrated therein are different from those in reality. Therefore, specific configurations shall be determined in consideration of the following explanation.

The embodiments described below represent examples of a device and a method for embodying technical thoughts of the present invention, and the technical thoughts of the present invention do not limit materials, shapes, configurations, arrangements, and so on of constituents to those described below. Various changes may be added to the technical thoughts of the present invention without departing from the technical scope set forth in the claims.

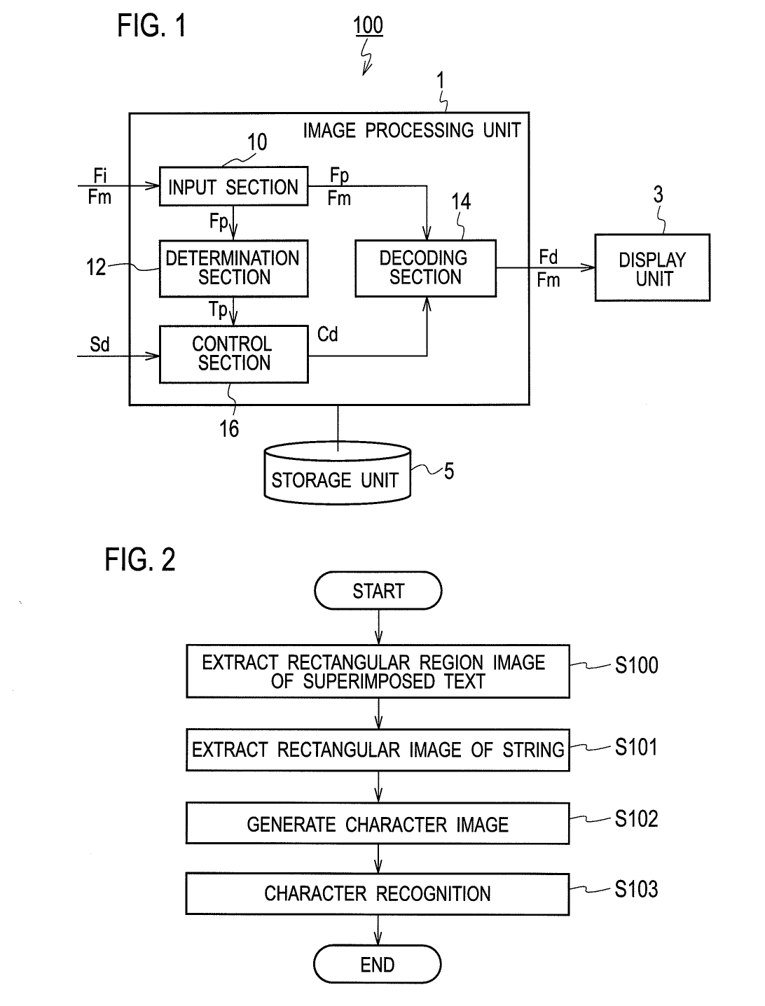

As shown in FIG. 1, a stereoscopic image display processing device 100 according to the embodiment has an image processing unit 1 and a storage unit 5 as a basic configuration, and includes a display unit 3 as an integrated or separate configuration of the stereoscopic image display processing device 100. The image processing unit 1 includes an input section 10, a determination section 12, a decoding section 14, and a control section 16.

The image processing unit 1 is configured by various processors and the like for controlling the stereoscopic image display processing device 100, and processing various signals input into the input section 10.

An input image signal Fi, and an identification signal Fm that defines a format of the input image signal Fi are input to the input section 10 of the image processing unit 1, and the input section 10 outputs a processed image signal Fp based on the identification signal Fm.

For example, an image signal output from an external device such as a Blue-ray disc (BD) recorder, or an image signal of broadcast received by a TV tuner is input as the input image signal Fi. Simultaneously, when an image signal is input through an HDMI cable that is connected to an external device such as a BD recorder, the identification signal Fm is input from the external device in order to identify the 3D format of the input image signal Fi based on the HDMI 1.4a specification.

When an external device is connected via a cable other than the HDMI cable, and broadcast received by a TV tuner is input as an image signal, a set value corresponding to a 3D decoding method that is arbitrarily set by a viewer via remote control is input as the format identification signal Fm.

When the identification signal Fm that is input in the input section 10 represents an interlaced signal for either 2D or 3D, the input section 10 executes interlace-progressive (IP) conversion processing of the input image signal Fi. The input section 10 outputs a progressive image after the IP conversion processing as the processed image signal Fp. Meanwhile, when a format other than above is input in the input section 10, the input section 10 outputs the input image signal Fi as it is as the processed image signal Fp.

The determination section 12 determines a state of superimposed text information in the processed image signal Fp. The “state of superimposed text information” means whether or not the processed image signal Fp contains superimposed text information. For example, the determination section 12 determines the state of superimposed text information based on whether or not a previously registered string is present in the processed image signal Fp. When a determination result indicates that the string is present, the determination section 12 outputs a value 1, and, when the string is not present, the determination section 12 outputs a value 0, as a determination signal Tp of superimposed text information.

For the determination section 12, a method described in, for example, Japanese Patent Application Publication No. 2009-217303 may be used.

The determination section 12 may be configured by dedicated hardware, or may use software to have a substantially equivalent function by using a CPU of a normal computer system. The determination section 12 includes an auxiliary storage device (not shown). The auxiliary storage device stores a program that determines superimposed text information. Also, the auxiliary storage temporarily stores data being processed and data of processing results in determination of superimposed text information.

Determination processing of superimposed text information executed at the determination section 12 according to the embodiment will be explained using a flowchart shown in FIG. 2. In step S100, a rectangular region image containing superimposed text characters is extracted from the processed image signal Fp. In step S101, a rectangular image in a pixel region, which is determined as a string, is extracted from the rectangular region image.

In step S102, the rectangular region image is converted into two values where pixels containing a character are converted into 1, and pixels containing no character are converted into 0 with respect to the rectangular image in the pixel region, and a character image is thus generated. In step S103, characters in the generated character image are recognized by using an existing optical character recognition (OCR) engine or the like. It is determined whether previously registered characters such as “breaking news”, “earthquake”, “tsunami”, “news”, and “seismic intensity” are present in the character image, and, a value 1 is output when such characters are present, and a value 0 is output when such characters are not present, as the determination signal Tp of superimposed text information.

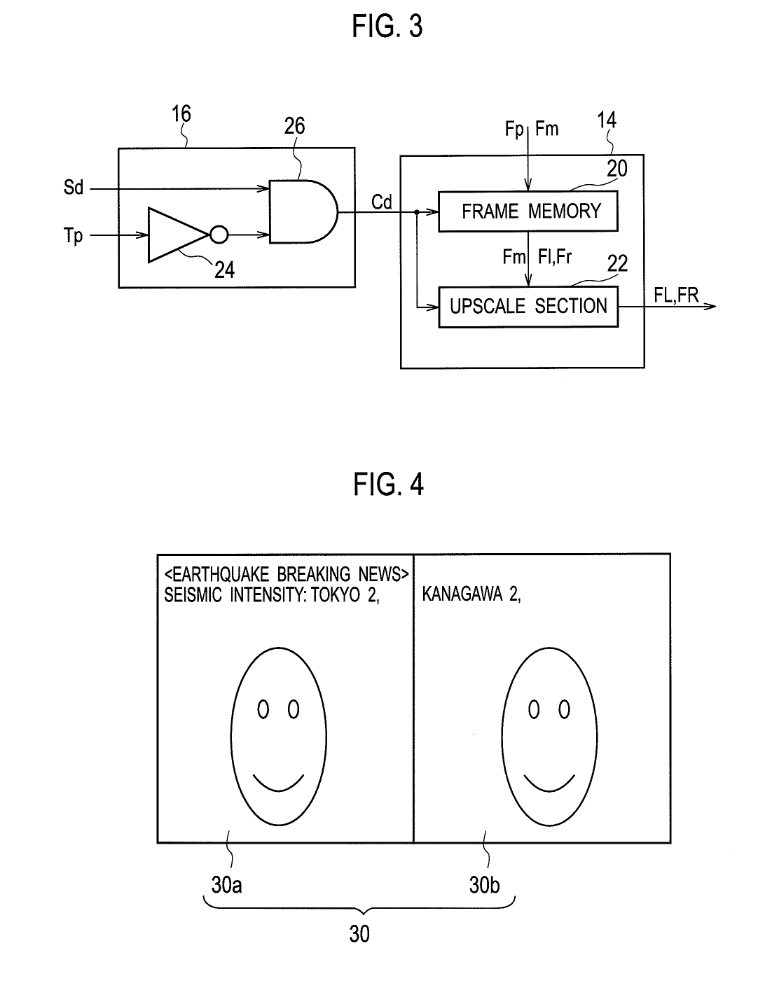

When it is determined at the determination section 12 that superimposed text information is not contained in the processed image signal Fp, and a 3D image signal is contained in the processed image signal Fp, the decoding section 14 executes 3D decoding processing in accordance with a format of the identification signal Fm and generates a display image signal Fd. As shown in FIG. 3, the decoding section 14 includes a frame memory 20 and an upscale section 22.

When a 3D image signal is contained in the processed image signal Fp, the control section 16 controls the decoding section 14 based on the sate of superimposed text information determined by the determination section 12.

When it is determined that superimposed text information is contained in the processed image signal Fp, the control section 16 controls the decoding section 14 so that the decoding section 14 does not execute 3D decoding processing of the processed image signal Fp, but outputs the processed image signal Fp and the superimposed text information as they are as the display image signal Fd.

When it is determined by the determination section 12 that superimposed text information is not contained in the processed image signal Fp, the control section 16 controls the decoding section 14 so that the decoding section 14 executes 3D decoding processing and outputs the display image signal Fd generated by the 3D decoding processing.

As shown in FIG. 3, the control section 16 includes a not gate 24, and an and gate 26.

As shown in FIG. 3, a mode selection signal Sd indicating whether or not a user has selected a 3D viewing mode is input to the and gate 26 of the control section 16, and the determination signal Tp regarding superimposed text information is also input to the and gate 26 via the not gate 24. A value of the mode selection signal Sd is 1 when the 3D viewing mode is selected, and is 0 when the 3D viewing mode is not selected.

The control section 16 outputs a control signal Cd as 1 only when the mode selection signal Sd is 1 and the determination signal Tp is 0. This means that the control signal Cd is limited to 0 when the determination signal Tp is 1, even if the mode selection signal Sd is 1.

The frame memory 20 of the decoding section 14 stores the processed image signal Fp input from the input section 10. The frame memory 20 separates a pair of 3D images within the processed image signal Fp based on the control signal Cd from the control section 16 and the identification signal Fm from the input section 10, and reads the pair of 3D images as an L image signal Fl and an R image signal Fr. The upscale section 22 enlarges the L and R image signals Fl and Fr based on the control signal Cd and the identification signal Fm, and outputs an L enlarged image signal FL and an R enlarged image signal FR to the display unit 3 as the display image signals Fd, respectively.

Specific operations of the frame memory 20 and the upscale section 22 of the decoding section 14 will be explained. When the determination signal Fm represents a 2D signal, the processed image signal Fp is read as it is for both the L image signal Fl and the R image signal Fr regardless of the value of the control signal Cd. The L and R image signals Fl and Fr are output as the L enlarged image signal Fl and the R enlarged image signal FR without being enlarged at the upscale section 22. In short, the processed image signal Fp is output as it is as the L and R enlarged image signals FL and FR.

Next, as shown in FIG. 4, a case will be explained where the identification signal Fm represents the side-by-side format. In the side-by-side format, when a broadcasting station does not superimpose same characters of superimposed text information at same positions in L and R images, respectively, but superimposes the characters by using an existing text superimposer like 2D broadcasting, the superimposed text information is superimposed across L and R images 30a and 30b of a processed image 30.

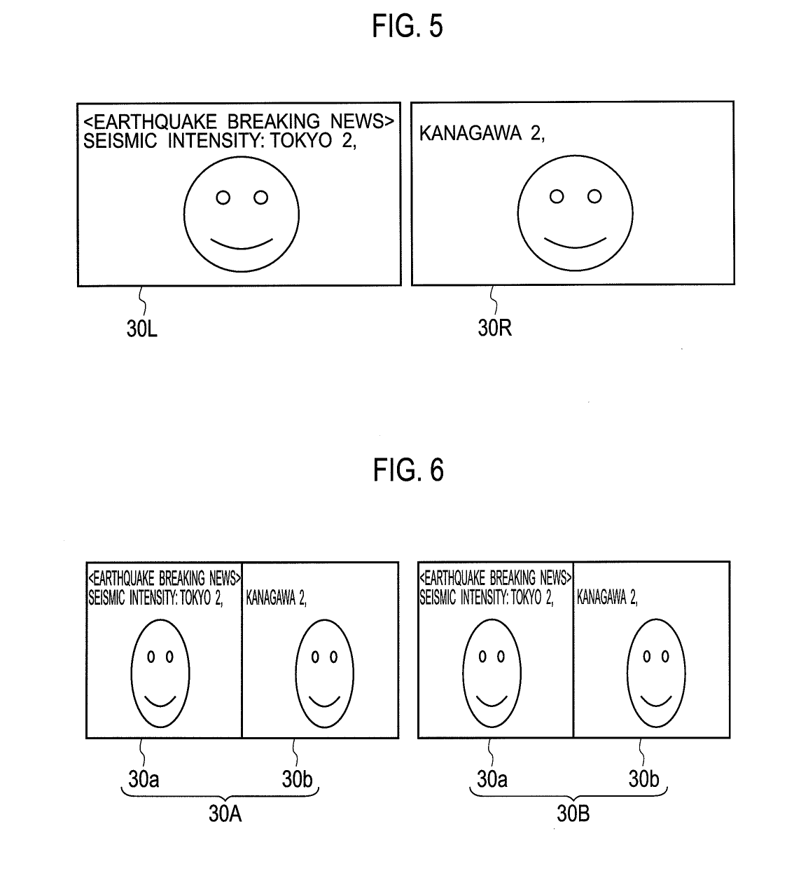

In this case, a superimposed text in the L image 30a and a superimposed text in the R image 30b do not have the same string. Therefore, conventionally, a superimposed text on an L enlarged image 30L and a superimposed text on an R enlarged image 30R have different strings, as shown in FIG. 5. When viewing in a 3D viewing mode, the superimposed texts are overlapped with each other on a display, thereby making the superimposed text information unreadable.

In the embodiment, when the control signal Cd is 1, in other words, when it is determined that no superimposed text information is present, a left half of the processed image 30 of the processed image signal Fp is read as the L image 30a, and the right half thereof is read as the R image 30b by the frame memory 20. The sizes of the L and R images 30a and 30b are doubled horizontally at the upscale section 22, respectively, and the L and R enlarged images 30L and 30R are output.

On the other hand, when the control signal Cd is 0, in other words, when superimposed text information is present, or the 3D viewing mode is off, the processed image 30 is output as the L and R enlarged images 30A and 30B, while remaining in the side-by-side state.

As shown in FIG. 6, the superimposed text on the L enlarged image 30A is superimposed across the L and R images 30a and 30b. Similarly, the superimposed text of the R enlarged image 30B is superimposed across the L and R images 30a and 30b. Since the strings of the respective superimposed texts are the same, it is possible to read the superimposed text information even when the L and R enlarged images 30A and 30B overlap each other.

As described above, in the embodiment, the side-by-side format is used to explain a 3D format. In the embodiment, the 3D decoding processing is not executed when the control signal Cd is 0 in a case of other formats. Processing of the decoding section 14 in a case of other formats will be explained below.

For example, when the identification signal Fm represents the top-and-bottom format at “1080p@23.98/24 Hz”, and when the control signal Cd is 1, an upper half of the processed image signal Fp is read as an L image signal Fl, and a lower half thereof is read as an R image signal Fr. The sizes of the L and R image signals Fl and Fr are doubled vertically at the upscale section 22, and output as an L enlarged image signal FL and an R enlarged image signal FR.

Meanwhile, when the control signal Cd is 0, the processed image signal Fp is output as the L and R image signals Fl and Fr while remaining in the top-and-bottom state. The L and R image signals Fl and Fr are output as L and R enlarged image signals FL and FR, respectively, without being enlarged at the upscale section 22. In short, the processed image signal Fp is output as it is as the L and R enlarged image signals FL and FR.

When the identification signal Fm represents the top-and-bottom format at “720p@50 or 59.94/60 Hz”, and when the control signal Cd is 1, an upper half of the processed image signal Fp is read as an L image signal Fl, and a lower half thereof is read as an R image signal Fr. The L and R image signals Fl and Fr are enlarged 1.5 times horizontally and 3 times vertically at the upscale section 22 so as to be enlarged to an image size equivalent to 1080p, and output as an L enlarged image signal FL and an R enlarged image signal FR, respectively.

Meanwhile, when the control signal Cd is 0, the processed image signal Fp is output as the L and R image signals Fl and Fr while remaining in the top-and-bottom state. The L and R image signals Fl and Fr are enlarged 1.5 times horizontally and 1.5 times vertically at the upscale section 22, and output as L and R enlarged image signals FL and FR, respectively. In short, the processed image signal Fp is enlarged to an image size equivalent to 1080p in the top-and-bottom state, and output as the L and R enlarged image signals FL and FR.

When the identification signal Fm represents the frame-packing format at “1080p@23.98/24 Hz”, an L image and an R image in an LR packing image that is input as the processed image signal Fp are read as an L image signal Fl, and an R image signal Fr, respectively, regardless of the value of the control signal Cd. The L and R image signals Fl and Fr are output as L and R enlarged image signals FL and FR without being enlarged at the upscale section 2.

When the identification signal Fm represents the frame-packing type at “720p@50 or 59.94/60 Hz”, an L image and an R image in a LR packing image that is input as the processed image signal Fp are read as an L image signal Fl and an R image signal Fr, respectively, regardless of the value of the control signal Cd. The L and R image signals Fl and Fr are enlarged 1.5 times in both horizontally and vertically to be enlarged to an image size equivalent to 1080p, and output as L and R enlarged signals FL and FR, respectively.

The display unit 3 is, for example, a display with Full-HD resolution using a frame sequential method. The display unit 3 stores the input L and R enlarged image signals FL and FR in a frame memory in the display unit 3, and reads and displays the L and R enlarged image signals FL and FR alternately per frame.

Ina case of the frame-packing format at “1080p@23.98/24 Hz”, and in a case of the top-and-bottom format at “1080p@23.98/24 Hz”, a frame frequency is different from other formats. Therefore, the display unit 3 reads the L and R enlarged image signals FL and FR stored in the frame memory while executing pull-down conversion of the L an R enlarged image signals FL and FR, and displays the same in the frame sequential method.

In the embodiment, a frame sequential display was used as the display unit 3, but the display unit 3 is not limited thereto. A line-alternate or glasses-free display may also be used, and input L and R enlarged image signals FL and FR may be displayed as L and R images in accordance with the display method.

The storage unit 5 is configured of a ROM (a read only memory), a RAM (a random access memory), or the like, and stores a stereoscopic image display processing program executed in the image processing unit 1 (a computer).

As explained above, in the stereoscopic image display processing device according to the embodiment, when it is determined at the determination section 12 that a previously registered characters such as “news” and “breaking news” is contained in the processed image signal that has been input, the processed image signal is output as it is without executing 3D decoding.

In the conventional technology, while 3D broadcast aired by a TV station is viewed in a 3D viewing mode, when a scene is broadcasted with a superimposed text such as breaking news that is superimposed across L and R images of the broadcast as shown in FIG. 4, and the scene is viewed in the 3D viewing mode, an image as shown in FIG. 5 is displayed and the characters of the superimposed text are not readable.

On the other hand, in the stereoscopic image display processing device according to the embodiment, images as shown in FIG. 6 are displayed even in the 3D viewing mode, thereby allowing a viewer to read the characters of the superimposed text without turning off the 3D mode.

With the configuration of the foregoing stereoscopic image display processing device, subtitles of movies or the like that are present at a lower part of a 3D screen could be detected as a superimposed text, and a problem happens that 3D decoding is stopped even though broadcast without any superimposed text superimposed thereon is actually viewed. Generally, a superimposed text showing breaking news and the like is often superimposed in a region in an upper half of a screen.

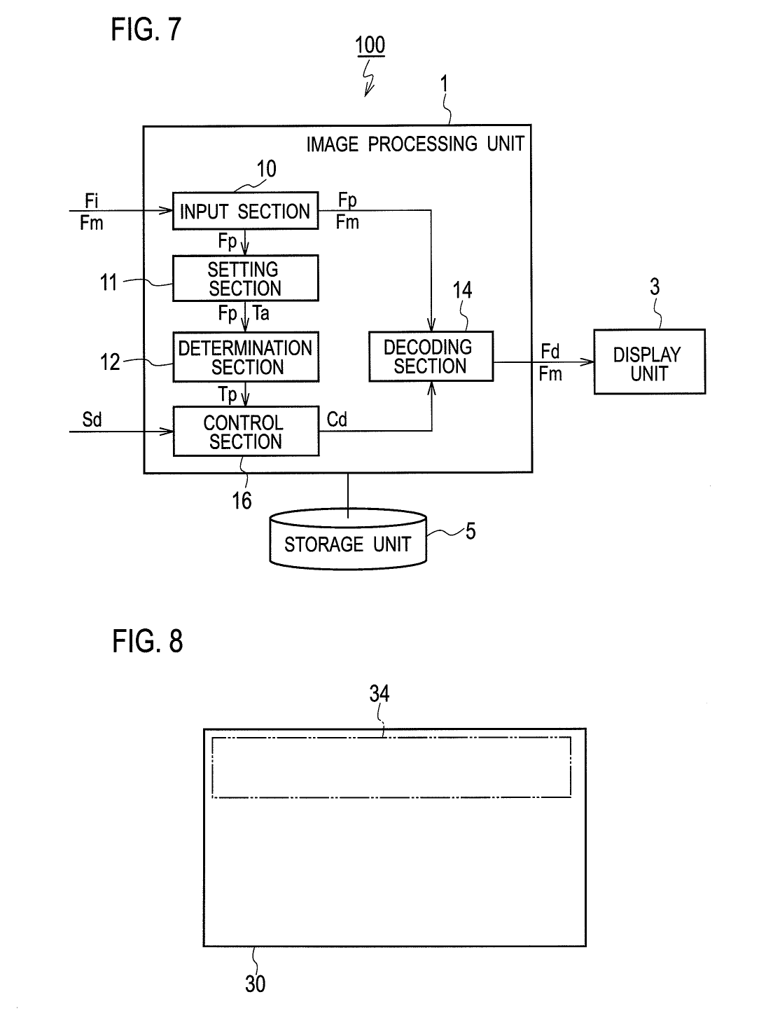

For example, as shown in FIG. 7, a setting section 11 is provided in the image processing unit 1, which sets a determination region where the determination section 12 executes superimposed text determination processing. As shown in FIG. 8, the setting section 11 sets a determination region 34 as a superimposed text determination processing executing region in the processed image signal that is output from the input section 10, and outputs the determination region 34 as region information Ta.

The determination section 12 determines superimposed text information in the determination region 34 that is set in the processed image 30, based on the region information Ta output from the setting section 11. Although the superimposed text information is determined in the determination region 34 that is set in an upper half of the processed image 30 as shown in FIG. 8, it is preferred that the determination region 34 be set arbitrarily.

As explained so far, since it is possible to arbitrarily set a region where superimposed text information is determined, false detection of strings such as subtitles of movies is prevented.

### Modification Examples

A recording and reproduction apparatus such as a BD recorder is used as an external device in order to play back package software or record and reproduce 3D broadcast. For example, in a case where a 3DTV is used for 3D viewing through a BD recorder, and when reproducing BD 3D software, both the recorder and the TV are automatically switched to operation modes suitable for a 3D format based on the HDMI 1.4a specification.

Meanwhile, when 3DTV broadcast recorded in a recorder (the side-by-side format is used in the 3DTV broadcast) is viewed in 3D, it is not possible to identify the 3D format and automatically switch operations. In such a case, the recorder side reproduces images in a 2D operation mode, and the TV side is manually switched to the side-by-side decoding mode and operated.

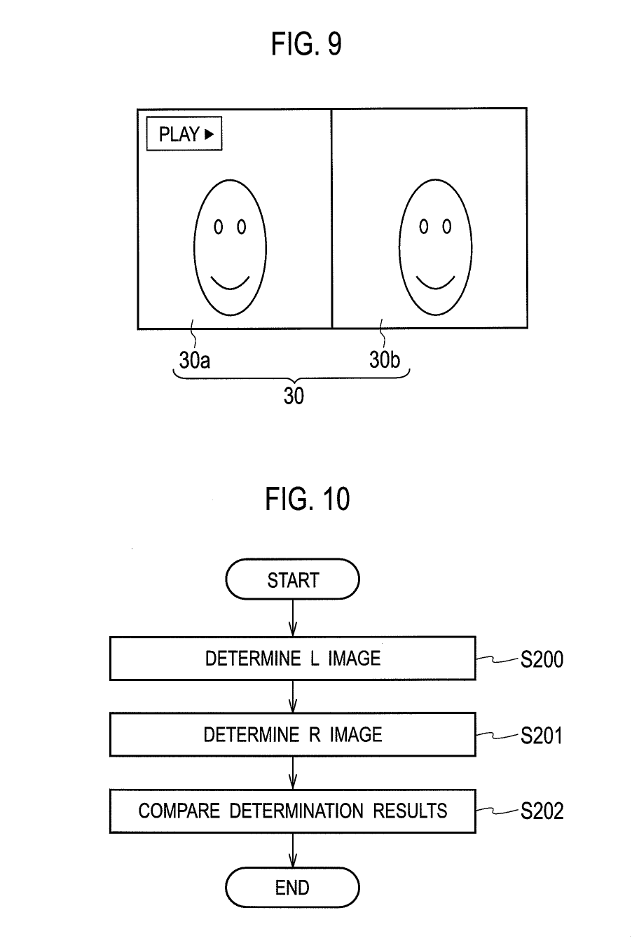

As the recorder is controlled during 3D viewing to play back or pause, or to display a menu screen, an OSD character image of the recorder is displayed. For example, as shown in FIG. 9, OSD characters “PLAY” is superimposed on the L image 30a.

In this case, since the recorder operates in a 2D mode, the same OSD characters are not displayed on an L image 30a and an R image 30b of a side-by-side image, but the OSD characters are superimposed on one frame of a processed image 30 of the side-by-side image as one frame of a 2D image. Therefore, normal stereoscopic view of the OSD characters is not possible.

Namely, when different OSD characters are present in L and R images 30a and 30b, the OSD characters are not readable. Also, when OSD characters are present only in either one of the L and R images 30a and 30b, flicker is felt. This leads to a problem that accumulation of eye fatigue is caused.

In the modification example of the embodiment, the determination section 12 determines not only whether or not superimposed text information is contained, but also whether or not the L and R images 30a and 30b have the same superimposed text information. In other words, the determination section 12 distinguishes between the L image 30a and the R image 30b in accordance with the identification signal Fm with respect to the input image signal Fi that has been input to the determination section 12, and detects strings from the respective L and R images 30a and 30b. The determination section 12 determines whether or not there is a string contained only in either one of the L and R images 30a and 30b.

The determination section 12 outputs a superimposed text information determination signal Tp which takes a value 1 when there is a string that is present only in either one of the L and R images 30a and 30b, and a value 0 when there is not such a string. This determination is carried out for each pair of the L and R images 30a and 30b.

The modification example of the embodiment is different from the embodiment in that it is determined not only whether or not superimposed text information is contained, but also whether or not the L and R images 30a and 30b have the same superimposed text information. The rest of the configurations are the same as those of the embodiment, and duplicated statements will be omitted.

Determination processing of superimposed text information executed at the determination section 12 according to the modification example of the embodiment will be explained by using a flowchart shown in FIG. 10.

In step S200, superimposed text information is detected in the L image 30a. For example, the processing is executed in accordance with the flowchart shown in FIG. 2 for the L image 30a separated from the pair of images within the processed image signal Fp. Character code data is generated based on a character recognition result in the L image 30a, and stored in the auxiliary storage device of the determination section 12.

In step S201, superimposed text information is detected in the R image 30b. Character code data is generated based on a character recognition result in the R image 30b, and stored in the auxiliary storage device of the determination section 12.

In step S202, the character code data is compared between the L and R images 30a and 30b, and it is determined whether or not there is a string that is present only in either one of the L and R image 30a and 30b. Based on a result of the character code data comparison, the determination signal Tp of the superimposed text information is generated.

Specifically, first, the determination section 12 determines whether or not there is a string that is present only in the L image 30a, and generates a 1-bit determination result signal J1. The determination section 12 determines whether or not each piece of the character code data detected in the L image 30a is detected in the R image 30b.

As a result of the comparison, when there is at least one piece of character code data that is not detected in the R image 30b, the determination section 12 outputs the determination result signal J1 as 1, and, when there is no such character code data, the determination section 12 outputs the determination result signal J1 as 0. The determination section 12 also outputs the determination result signal J1 as 0 when there is no superimposed text information detected in the L image 30a at all.

Similarly, the determination section 12 determines whether or not there is a string that is present only in the R image 30b, and generates a 1-bit determination result signal J2. The determination section 12 determines whether or not each piece of the character code data detected in the R image 30b is detected in the L image 30a.

As a result of the comparison, when there is at least one piece of character code data that is not detected in the L image 30a, the determination section 12 outputs the determination result signal J2 as 1, and, when there is no such character code data, the determination section 12 outputs the determination result signal J2 as 0. The determination section 12 also outputs the determination result signal J2 as 0 when there is no superimposed text information detected in the R image 30b at all.

The determination section 12 generates the determination signal Tp of the superimposed text information by using the determination result signals J1 and J2. For example, the determination section 12 carries out logical operation in which the value 0 is taken only when both the determination judgment signals J1 and J2 are 0, and the value 1 is taken otherwise. In other words, when there is superimposed text information that is present only in the L image 30a, or there is superimposed text information that is present only in the R image 30b, the determination signal Tp becomes the value 1. The determination signal Tp is a 1-bit signal, and is output from the determination section 12 as a final determination signal.

In the modification example of the embodiment, when different OSD characters are superimposed in the L and R images 30a and 30b or when OSD characters are superimposed on either one of the L and R images 30a and 30b in a 3D viewing operation mode, 3D display is automatically switched off. As a result, the OSD characters become viewable. In addition, since a viewer no longer sees different OSD characters with the left and right eyes or sees OSD characters with only one eye, eye fatigue is not induced.

<Stereoscopic Image Display Processing Program>

The stereoscopic image display processing program causes a computer to execute each processing in the foregoing image processing unit 1 as an instruction. It is also possible to store the stereoscopic image display processing program in a computer readable storage medium, and provide the stereoscopic image display processing program as a stereoscopic image display processing program stored in a computer readable storage medium.

### Other Embodiments

Although the embodiment of the present invention was explained as above, it should not be understood that the present invention is limited to the statements and drawings included in this disclosure. Various alternative embodiments, examples, operation techniques will be obvious to those skilled in the art from this disclosure. Therefore, the technical scope of the present invention is defined only by a matter specifying the invention according to the reasonable scope of patent claims based on the foregoing explanation.

What is claimed is:

1. A stereoscopic image display processing device, comprising:
a decoding section configured to output a display image signal based on an input processed image signal after executing 3D decoding processing of the processed image signal based on a 3D format of the processed image signal, or without executing the 3D decoding processing;
a determination section configured to determine a state of superimposed text information in the input processed image signal; and
a control section configured to control the decoding section to execute or not to execute the 3D decoding processing of the processed image signal based on a determination result by the determination section.

2. The stereoscopic image display processing device according to claim 1, wherein
the determination section determines whether or not the processed image signal contains superimposed text information, and
the control section controls the decoding section to execute the 3D decoding processing when the determination section determines that the processed image signal contains no superimposed text information, and controls the decoding section not to execute the 3D decoding processing when the determination section determines that the processed image signal contains superimposed text information.

3. The stereoscopic image display processing device according to claim 1, wherein
the determination section determines whether or not superimposed text information in the processed image signal is the same in a right image and a left image, and
the control section controls the decoding section to execute the 3D decoding processing when the determination section determines that the superimposed text information in the processed image signal is the same in the right image and the left image, and controls the decoding section not to execute the 3D decoding processing when the determination section determines that the superimposed text information in the processed image signal is different in the right image and the left image.

4. The stereoscopic image display processing device according to claim 1, further comprising:
a setting section configured to set an image region in which the determination section determines a state of the superimposed text information in the input processed image signal, wherein
the determination section determines a superimposed text state in the image region set by the setting section.

5. The stereoscopic image display processing device according to claim 4, wherein the setting section sets the image region in an upper part of an image that is configured by the processed image signal, as an image region in which a state of superimposed text information in the processed image signal is determined.

6. A stereoscopic image display processing method, comprising:
determining a state of superimposed text information in an input processed image signal; and
controlling execution or non execution of 3D decoding processing of the processed image signal based on a determination result regarding the state of the superimposed text information.

7. A stereoscopic image display processing program for causing a computer to execute the instructions, comprising:
an instruction for determining a state of superimposed text information in an input processed image, and
an instruction for controlling execution or non execution of 3D decoding processing of the processed image signal based on a determination result regarding the state of the superimposed text information.
